(19) United States
(12) Patent Application Publication
(10) Pub. No.: US 2014/0043464 A1
(43) Pub. Date: Feb. 13, 2014

(54) COORDINATE MEASURING MACHINE FOR DETERMINING SPATIAL COORDINATES ON A MEASUREMENT OBJECT

(71) Applicant: Carl Zeiss Industrielle Messtechnik GmbH, Oberkochen (DE)

(72) Inventors: Thomas ENGEL, AALEN (DE); Johannes WINTEROT, JENA (DE)

(73) Assignee: Carl Zeiss Industrielle Messtechnik GmbH, Oberkochen (DE)

(21) Appl. No.: 13/961,605

(22) Filed: Aug. 7, 2013

Related U.S. Application Data
(63) Continuation of application No. PCT/EP2012/065398, filed on Aug. 7, 2012.
(60) Provisional application No. 61/680,371, filed on Aug. 7, 2012.

(51) Int. Cl. H04N 7/18; G02B 7/02

(52) U.S. Cl. CPC H04N 7/183; G02B 7/02
USPC 348/94; 359/811

(57) ABSTRACT

A coordinate measuring machine has a workpiece support for holding a measurement object, and a measuring head displaceable relative to the workpiece support. An evaluation and control unit determines geometric properties on the measurement object depending on the position of the measuring head relative to the workpiece support and on sensor data from an optical sensor carried on the measuring head. The optical sensor includes a camera and a lens assembly having a lens body, which forms a light-entry opening and a light-exit opening with an interface for connecting the camera. The lens assembly comprises a number of lens elements arranged in the lens body. A separate cover glass is arranged in the region of the light-entry opening, and sits in front of the lens elements as a first transparent component. Preferably, the lens elements are corrected depending on optical characteristics of the cover glass.

### CROSS-REFERENCES TO RELATED APPLICATIONS

This application is a continuation of International PCT application No. PCT/EP2012/065398, filed on Aug. 7, 2012. This application also claims priority from U.S. provisional application No. 61/680,371, filed on Aug. 7, 2012. The entire contents of these prior applications are incorporated herein by reference.

### BACKGROUND OF THE INVENTION

The present invention relates to a coordinate measuring machine using an optical sensor for determining spatial coordinates on a measurement object and to a lens assembly designed for use in combination with the optical sensor of such a coordinate measuring machine.

EP 1 071 922 B1 discloses a prior art coordinate measuring machine using an optical sensor. The known coordinate measuring machine has a probe element, which is preferably arranged at the end of an elastically flexible optical fiber. The probe element serves to touch a measurement point on a measurement object. With the aid of an optical sensor, which includes a camera and a lens assembly, it is possible to detect deflections of the probe element when probing the measurement object. On the basis of the deflection of the probe element and on the basis of the position of the optical sensor relative to the measurement object, it is then possible to determine spatial coordinates for the probed measurement point. Alternatively, the known coordinate measuring machine is supposed to offer the option of measuring the surface topography of a measurement object without using a probe element, i.e. in a purely optical fashion.

JP 2011-169661 discloses an optical measuring machine having a camera and a telecentric optical system which comprises a front lens element, a back side lens element and a telecentric stop. The measuring machine further comprises a laser-based autofocus system which determines a position of the measurement object on the optical axis of the telecentric system using laser light.

The use of optical sensors in conjunction with coordinate measuring machines makes it possible, in many cases, to measure geometric properties of a measurement object very quickly. However, a disadvantage of known coordinate measuring machines with optical sensors lies in the sensitive optical units, which must be kept clean so that contaminants do not adversely affect the quality of the measurement. Hence coordinate measuring machines with optical sensors are inexpedient for applications the vicinity of production areas, where dust, moisture and/or dirt particles are created. Thus tactile coordinate measuring machines are generally used these days for such measurements in the vicinity of production areas, or measurements in the vicinity of production areas are dispensed with entirely.

### SUMMARY OF THE INVENTION

It is desirable to provide an optical coordinate measuring machine that enables use in industrial production areas while incurring low costs. Accordingly, it is an object of the present invention to provide for a corresponding coordinate measuring machine.

In accordance with one aspect of the present invention, there is provided a coordinate measuring machine for determining spatial coordinates on a measurement object, comprising a workpiece support for holding the measurement object, comprising a measuring head which can be displaced relative to the workpiece support and carries an optical sensor, and comprising an evaluation and control unit configured to determine geometric properties on the measurement object depending on a position of the measuring head relative to the workpiece support and depending on sensor data from the optical sensor, wherein the optical sensor includes a lens assembly and a camera which is configured to record an image of the measurement object through the lens assembly, wherein the lens assembly has a lens body which has a light-entry opening and a light-exit opening with an interface for connecting the camera, wherein the lens assembly further comprises a stop and a number of lens elements, which are arranged in the lens body and together define an optical axis, and wherein a separate cover glass is arranged in the region of the light-entry opening, which cover glass sits in front of the lens elements as first transparent component.

In accordance with another aspect, there is provided a lens assembly for a coordinate measuring machine, comprising a lens body which has a light-entry opening and a light-exit opening with an interface for connecting a camera, and comprising a stop and a number of lens elements which are arranged in the lens body and together define an optical axis, wherein a separate cover glass having a planar front side and a planar back side is arranged in the region of the light-entry opening, which cover glass has optical characteristics and sits in front of the lens elements as first transparent component at the light-entry opening, wherein the lens elements are corrected as a function of the optical characteristics, such that at least one of spherical aberrations and chromatic aberrations of the lens assembly are smaller when the cover glass is installed than without the cover glass being installed.

The novel coordinate measuring machine comprises a lens assembly, in front of which or on which a cover glass is arranged on the object side as front-most element. The cover glass is preferably arranged at a defined distance along the optical axis from the front-most lens element of the lens assembly, wherein the distance is selected in such a way that dirt particles, which adhere to the cover glass, lie outside of the depth-of-field range of the lens elements and/or lie outside of all object planes, image planes, pupil planes and planes of the whole imaging beam path conjugate thereto. The cover glass can consist of “real” glass or of another transparent material (in relation to electromagnetic radiation in the optical wavelength range between 400 and 700 nm and/or in the adjacent infrared and/or UV range). In particular, the cover glass can be made of a polymer and/or be realized in the form of a thin film.

In any case, the cover glass forms the first transparent element, through which light enters the lens body. It closes off the lens body and the lens elements arranged within the lens body toward the front, preferably in a dust-tight manner. The incident light only reaches the lens elements after it has passed through the cover glass. Hence the cover glass forms an optical unit protection, which protects the sensitive lens elements from dirtying and also, in some exemplary embodiments, from scratches and similar damages. The cover glass makes it possible, in a cost-effective manner, to employ a coordinate measuring machine with an optical sensor directly in regions in the vicinity of production facilities in a production plant, where dirt is created or at least can be created as a result of the manufacturing processes.

Although the cover glass would have to be cleaned regularly in the case of such use, such cleaning is much simpler and poses a lower risk in the case of a pure protective glass than cleaning the sensitive lens elements, on which the imaging properties and the imaging quality of the lens decisively depend. This is because, in contrast to the lens elements, the imaging properties of the lens assembly are only influenced to a very small part, if at all, by the cover glass. This is precisely what the cover glass distinguishes from the subsequent lens elements in the beam path. The positioning of the cover glass in or on the lens assembly is much more robust in respect of manufacturing tolerances than in the case of the lens elements. Hence, if need be, replacement is substantially simpler and more cost-effective.

The novel coordinate measuring machine enables use in the vicinity of production areas, for example in the metal and automotive industries, as a result of the cover glass. The necessary regular cleaning of the cover glass is simpler, more cost-effective and connected with a lower risk of causing permanent damage by scratches than the comparable cleaning of a front lens element. If need be, a separate cover glass can be replaced more easily than a damaged or much dirtied lens element. The aforementioned object is therefore achieved in its entirety.

The new coordinate measuring machine is therefore based on the concept of arranging an additional transparent element on the lens body in addition to the lens elements, which primarily determine the imaging properties of the measurement lens assembly. Such a measure is very unusual for a measurement lens assembly, the optical properties of which are decisive for the quality and accuracy of measurement, since each element in the beam path of the incident light as a matter of principle influences the imaging properties. Arranging a cover glass in front of the lens elements of a measurement lens assembly can therefore have an adverse effect on the measurement accuracy, which is an undesirable effect for a coordinate measuring machine. In a particularly preferred embodiment, the lens elements of the lens assembly are therefore corrected depending on the optical properties of the cover glass, i.e. the optical properties of the cover glass are taken into account in the lens element design of the lens assembly. This can manifest itself in particular by virtue of the fact that spherical and/or chromatic aberrations of the lens assembly in the longitudinal and/or transverse direction without the cover glass are greater than with the cover glass. The refinement enables very high measurement accuracy in conjunction with the novel protection of the lens.

In a further refinement, the cover glass has a planar front side and a planar back side, which are each arranged transversely with respect to the optical axis.

In this refinement, the cover glass has two refractive surfaces transverse to the optical axis, namely the front side and the back side, which are respectively planar. The planar front side of the cover glass forms a planar front glass surface of the lens. The planar glass surface enables particularly simple cleaning. As a result of the fact that the cover glass also has a planar back side, the optical influence of the cover glass on the properties of the measurement lens are moreover very low.

In a further refinement, the front side and the back side of the cover glass are plane parallel to one another.

In this refinement, the cover glass is a thin transparent pane, which is preferably circular. This embodiment allows a particularly cost-effective realization. It is particularly advantageous if the cover glass is detachably arranged on the lens body in such a way that it can be replaced without much outlay by an operator of the coordinate measuring machine, i.e. for example a metrologist in a manufacturing environment. The cover glass can then be designed as a cost-effective disposable part, such that, if in doubt, there merely is a cost-effective replacement of the cover glass in place of complicated cleaning. In preferred refinements, the cover glass can be replaced without using tools, or commercially available tools suffice, such as a screwdriver or the like.

In an alternative refinement, the front side and the back side of the cover glass extend obliquely with respect to one another.

In this refinement, the cover glass is a wedge plate, which, in cross-section, is thicker at one edge than at the other one. In this refinement, the production of the cover glass can be slightly more expensive than in the case of two plane parallel sides. However, an advantage of the refinement is that the back side of the cover glass in particular can be arranged very easily at an angle that differs from 90° to the optical axis. Such an angle, i.e. an angled position of the back side of the cover glass, advantageously contributes to keeping reflections in the lens body away from the camera. In other words, this refinement helps to keep interfering light, which may occur on the back side of the cover glass, away from the entrance to the camera. Accordingly, in the preferred exemplary embodiments, the back side of the cover glass is angled with respect to the optical axis in such a way that the reflection of a light beam incident on the back side parallel to the optical axis cannot emerge through the light-exit opening of the lens assembly.

In a further refinement, the cover glass is arranged obliquely with respect to the optical axis.

In this refinement, the normal vector on the front side and on the back side of the cover glass includes an angle that differs from zero with the optical axis. In some exemplary embodiments, the angle lies between 0.5° and 5°. This refinement also contributes to avoiding, at the front side and the back side of the cover glass, undesired reflections onto the measurement object and/or into the camera. Accordingly, this refinement contributes in a simple manner to avoiding negative influences of the illumination on the measurement accuracy.

In a further refinement, the cover glass is arranged in a non-destructibly detachable manner in the region of the light-entry opening. The cover glass is preferably arranged in such a way that a user can replace the cover glass without tools or with a commercially available manual tool.

The refinement enables very quick replacement of the cover glass in the case of extensive dirtying or in the case of damage to the cover glass by scratches or the like. Hence, this refinement contributes to maintaining a measurement operation with unchanging high quality in environments in the vicinity of manufacturing. As a “wear part”, the cover glass can also be exposed to very inexpedient environmental conditions.

In a further refinement, the lens body has a lens body mount, in which the cover glass is arranged.

In this refinement, the cover glass is attached to the lens body itself. The cover glass is preferably an integral part of the lens assembly, i.e. the cover glass may be arranged in the lens body. Nevertheless, the cover glass may be non-destructively detachable in preferred exemplary embodiments. In some exemplary embodiments, the lens body has a mount, into which the cover glass is inserted transversely with respect to the optical axis. In other cases, the mount may be a screwed mount and the cover glass may have a counter-mount, which is screwed to the lens mount. Furthermore, the lens body may have a bayonet closure, onto which the cover glass is attached, or the cover glass may be clipped onto the lens body and/or held by magnets. An advantage of the refinement is that the cover glass is integrated into the “interference contour” of the lens assembly. It is easier for the user of the coordinate measuring machine to avoid collisions between the lens assembly and measurement object during the measurement procedure. Moreover, this refinement enables a particularly good seal of the lens assembly against dust and moisture.

In a further refinement, the coordinate measuring machine comprises a cover glass holder, which holds the cover glass in front of the light-entry opening. The cover glass holder is preferably mechanically decoupled from the lens body and/or the lens elements.

In this refinement, the cover glass is arranged in front of the light-entry opening by a separate holder. The holder can be embodied in the form of a sleeve, which surrounds the lens assembly as a whole. This refinement allows very good sealing. In the case of mechanical decoupling, the cover glass holder also serves as collision protection for the lens assembly. Accordingly, the holder can comprise a sensor, which responds in the case of a mechanical load above a defined threshold and generates a stop signal. In one exemplary embodiment, the holder may comprise elastic holding elements, for example in the form of rubber cushions or metal springs, which yield in the case of a collision and thereby protect the lens assembly. Here, use is made of the fact that the cover glass is significantly less sensitive to assembly tolerances than the lens elements due to its lack of lens-element properties.

In a further refinement, the evaluation and control unit comprises a storage device with calibration data, which represent optical properties of the lens assembly, wherein the calibration data include data representing the cover glass.

In this refinement, data, which represent the optical properties of the cover glass and are of importance for defined measurement accuracy, are stored in the evaluation and control unit of the coordinate measuring machine. Calibration data within the scope of this refinement are any type of data, which are important for the meteorological evaluation of a light signal recorded by the lens assembly. The evaluation and control unit is configured to determine geometric properties on the measurement object, inter alia depending on the optical properties of the cover glass. In some particularly preferred exemplary embodiments, the data represent a spherical and/or longitudinal chromatic aberration of the lens assembly, which is influenced by the cover glass. The refinement contributes to an unchangingly high measurement accuracy, even if the cover glass is replaced, since, in this case, adapted calibration data can very easily be stored in the storage device of the evaluation and control unit.

In a further refinement, the coordinate measuring machine comprises an orientation element, which determines a defined rotational position of the cover glass about the optical axis.

In this refinement, the orientation element enables a reproducible position of the cover glass in relation to the lens body. The orientation element can be a groove, a pin, a projection, a bead or any other “discontinuity point”, which, for example, is formed on the lens body mount, the holder and/or the cover glass and ensures that the cover glass can only be positioned in one or at most two or three defined rotational positions. In the case of two or three rotational positions, the orientation element may provide a kinematic mount of the cover glass. The refinement is particularly advantageous if the cover glass is a wedge plate or has another “un-symmetry” in respect of the rotational position about the optical axis. In this refinement, the cover glass can be assembled more easily and more quickly in the correct position, which is advantageous, particularly during the replacement by a user. This refinement moreover contributes to an unchangingly high measurement accuracy. The orientation element further contributes to the replacement of the cover glass by a user being designed in a failsafe manner. In some exemplary embodiments, the orientation element may be designed to monitor the correct position of the cover glass, for example with the aid of a circuit, which is closed or opened by the orientation element. In some cases, the cover glass may comprise an identification chip, which identifies the individual cover glass. The identification chip may be coupled with the orientation element in such a way that an identification of the cover glass is only possible when the cover glass is attached to the lens body in the correct position. It is advantageous if the identification chip moreover includes individual calibration data, which characterize the cover glass and which can be read by the evaluation and control unit of the coordinate measuring machine.

In a further refinement, a seal is provided for sealing the lens body together with the cover glass in a dust-tight and/or moisture-tight fashion.

In this refinement, the cover glass protects the interior of the lens body against the ingress of dust and/or liquids, which is a very advantageous realization for the use in regions in the vicinity of production areas in industrial manufacturing. The cover glass can advantageously be pressed against a sealing ring by a threaded ring, a bayonet closure, magnetically and/or by a latching or snap-in closure.

In a further refinement, the cover glass has a frame, into which an inherently flexible, transparent film is clamped.

In this refinement, the cover glass is realized in the style of a pellicle, i.e. as a very thin protective film, as is used, for example, for protecting exposure masks in the semiconductor industry. The advantage of this refinement is that the “cover glass” can be realized very thinly and barely changes the optical imaging properties of the measurement lens.

In a further refinement, the cover glass has a rigid glass body.

In this refinement, which, in principle, can be combined with the aforementioned film, the transparent cover glass is a rigid transparent element. An advantage of this refinement is that the lens elements of the lens assembly are also protected against mechanical influences, such as in the case of a collision of the lens assembly with the measurement object.

In a further refinement, the cover glass can be provided with what is known as a nano-coating with lotus effect.

Suitable nano-coating is, for example, supplied for spectacle lenses by Carl Zeiss, Germany, under the trademark Lotu Tec. An advantage thereof is that liquids and dirt particles contained therein roll off. The cover glass becomes less dirty and can moreover be cleaned more easily.

It is to be understood that the features mentioned above and yet to be explained below can be used not only in the respectively specified combination, but also in other combinations or on their own, without departing from the scope of the present invention.

### BRIEF DESCRIPTION OF THE DRAWINGS

Exemplary embodiments of the invention are illustrated in the drawing and will be explained in more detail in the following description. In detail:

FIG. 1 shows an exemplary embodiment of the novel coordinate measuring machine in a view obliquely from the front,

FIG. 2 shows a schematic illustration of the lens assembly from the coordinate measuring machine from FIG. 1,

FIG. 3 shows a schematic illustration for a cover glass, which is realized in the style of a pellicle,

FIG. 4 shows a sectional illustration of the lens-element groups of the lens assembly from FIGS. 2 and 3 in accordance with a preferred exemplary embodiment, wherein the lens-element groups are illustrated in five different working positions, which represent different magnifications in the case of respectively the same working distance, and

FIG. 5 shows a schematic illustration of a further exemplary embodiment.

### DETAILED DESCRIPTION OF THE PREFERRED EMBODIMENTS

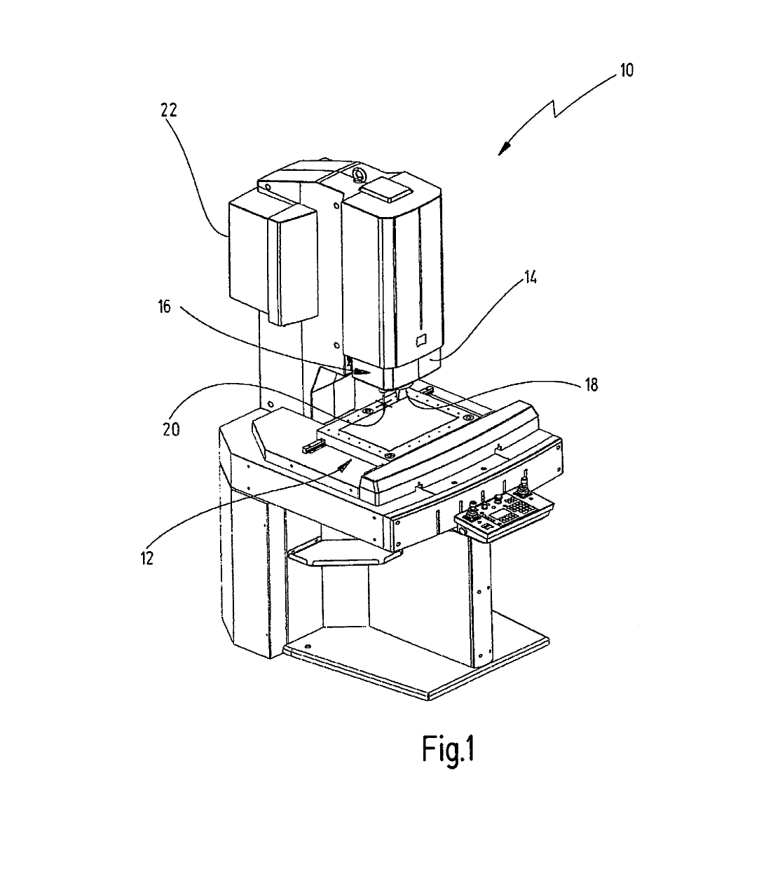

In FIG. 1, an exemplary embodiment of the novel coordinate measuring machine is denoted by reference sign 10 in its entirety. In this exemplary embodiment, the coordinate measuring machine 10 has a workpiece support in the form of an X-Y table 12. A quill 14 is arranged above the X-Y table 12. The quill 14 carries a measuring head 16, which in this case holds an optical sensor 18 and a separate tactile sensor 20. In principle, the measuring head can be a pure holding plate, on which various sensors can be attached. Using the tactile sensor 20, the coordinate measuring machine 10 can, in a manner known per se, touch a measurement point on a measurement object, which is arranged on the X-Y table 12 for this purpose. In order to touch the measurement point, the tactile sensor 20 is displaced relative to the measurement object using the X-Y table 12 and the quill 14. Spatial coordinates of the probed measurement point can then be determined in a known manner on the basis of the respective positions of the X-Y table and the quill.

The coordinate measuring machine 10 is a preferred example of a multi-sensor coordinate measuring machine, in which, in addition to the optical sensor 18, a tactile sensor 20 can be employed for measuring a measurement object. Alternatively, the novel coordinate measuring machine can merely have one or more optical sensors in other exemplary embodiments.

Moreover, the present invention is not restricted to coordinate measuring machines which have the machine design illustrated in FIG. 1. In principle, the novel coordinate measuring machine can be designed with a bridge design, portal design, horizontal-arm design or any other machine design.

Reference sign 22 denotes an evaluation and control unit, which firstly controls the drives (not denoted here) of the coordinate measuring machine 10 in order to displace the measuring head 16 relative to a measurement object. Secondly, the evaluation and control unit 22 reads in sensor data from the optical and/or tactile sensor 18, 20 and determines spatial coordinates for one or more measurement points on the measurement object depending on these sensor data and depending on the respective position of the measuring head and X-Y table. The principle method of operation of such a coordinate measuring machine is known to persons skilled in the relevant art and therefore not explained in any more detail below.

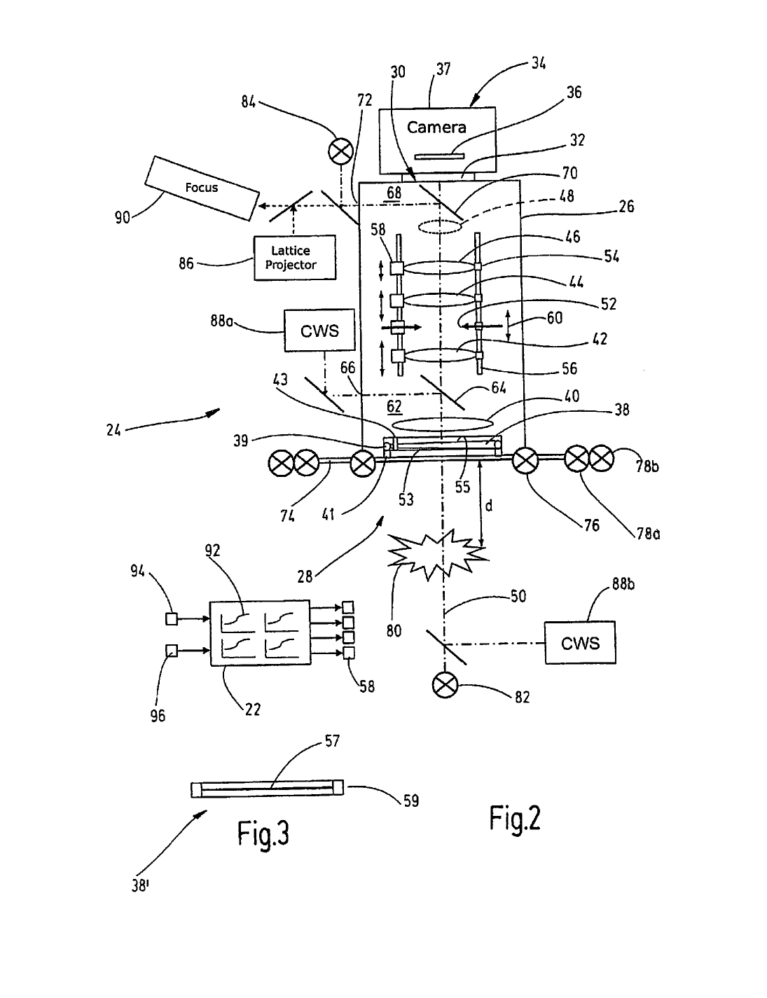

FIG. 2 shows a preferred exemplary embodiment of the optical sensor 18, wherein, to be precise, the optical sensor 18 includes several optical sensors in this exemplary embodiment, which optical sensors can optionally be present and used. The novel lens assembly can moreover be combined with further optical sensors, e.g. with a sensor measuring by exploiting deflectometric characteristics of a measurement object.

The sensor 18 includes a lens assembly 24 with a lens body 26. In typical exemplary embodiments, the lens body 26 is a tube with a light-entry opening 28 and a light-exit opening 30, which are arranged at opposite ends of the tube. However, in principle, the lens body 26 can also have a shape differing from that of a tube.

Formed on the light-exit opening 30 is an interface 32, which serves for connecting a camera 34 with an image sensor 36. In preferred exemplary embodiments, the interface 32 is a standardized or commercially widespread interface for coupling cameras and lens assemblies, for example a so-called F-mount or a so-called C-mount. In other exemplary embodiments, the interface 32 may be a proprietary interface, which, in particular, makes it possible to connect the housing 37 of the camera 34 permanently and directly with the lens body 26 to form one assembly, for example by screwing and/or adhesive bonding. In principle, it is also possible for other standardized or proprietary interfaces to be used for connecting the camera 34 to the lens body 26.

In the region of the light-entry opening 28, which defines the distal end of the lens assembly 24, a cover glass 38 is arranged on the lens body 26. Here, a lens-element system with a first lens-element group 40, a second lens-element group 42, a third lens-element group 44 and a fourth lens-element group 46 is arranged between the cover glass 38 and the light-exit opening 30 of the lens assembly 24. In some exemplary embodiments, a fifth lens-element group, which is illustrated here with dashed lines, may be arranged between the fourth lens-element group 46 and the light-exit opening 30. The lens-element groups 40-48 define an optical axis 50 and they are each arranged centrally with respect to the optical axis 50 in the illustrated exemplary embodiment.

A stop 52 is arranged between the second lens-element group 42 and the third lens-element group 44. In the preferred exemplary embodiments, the stop 52 is an iris diaphragm, i.e. a stop, the clear internal diameter of which can be varied.

Here, the second, third and fourth lens-element groups 42, 44, 46 and the stop 52 each are coupled to their own carriage 54, which can be moved along two guide rails 56. Furthermore, the three lens-element groups and the optical stop 52 each are coupled to a respective electric drive 58 in this exemplary embodiment. With the aid of the drives 58, it is possible here to displace the second, third and fourth lens-element groups and the stop 52 parallel to the optical axis 50, as indicated using the arrows (e.g. arrow 60). In contrast thereto, the first lens-element group 40 and the optional fifth lens-element group 48 are arranged fixed in the lens body 26 in the preferred exemplary embodiments.

In some exemplary embodiments, the cover glass 38 can be a circular glass pane with a screwed thread, which is screwed into a corresponding threaded mount at the distal end of the lens body 26. In the illustrated exemplary embodiment, the cover glass is a wedge plate, which is inserted from the front into a support of the lens body 26. Reference sign 39 denotes a sealing ring, in this case in the form of an O-ring, which seals the interior of the lens body 26 together with the cover glass 38 in a moisture-tight and dust-tight fashion. Here, the cover glass 38 is, together with a screw ring 41, pressed against the sealing ring and screwed into the support. Reference sign 43 denotes a pin, which serves as orientation element. The cover glass 38 accordingly has a hole, into which the pin 43 engages in order to set a unique rotational position of the wedge plate 38 about the optical axis 50.

In other exemplary embodiments, the cover glass 38 may be inserted from the side into a recess in the lens body 26. In further exemplary embodiments, the cover glass may be clipped, adhesively bonded, connected via a bayonet connection or otherwise connected to the lens body. By way of example, the cover glass may be attached on the lens body 26 using magnets. In all preferred exemplary embodiments, the cover glass 38 is connected to the lens body 26 in such a way that a user of the coordinate measuring machine 10 can replace the cover glass 38 without damaging the lens assembly 24, i.e. in a nondestructive manner. The attachment of the cover glass is advantageously designed in such a way that the lens assembly can remain on the measuring head when replacing the cover glass.

In the exemplary embodiment of FIG. 2, the cover glass 38 is a wedge-shaped glass plate, the thickness of which increases from one edge to the other edge. In this case, the cover glass 38 has a wedge angle, which is selected in such a way that a reflection on the front side 53 or back side 55 of the cover glass 38 cannot reach the image sensor 36 of the camera 34. In the exemplary embodiment of FIG. 2, the cover glass 38 is arranged in such a way that the front side 53 thereof lies in a plane parallel fashion with respect to the light-entry opening 28, while the back side 55 is arranged at a slight angle thereto. In other exemplary embodiments, the cover glass 38 can be arranged in such a way that the front side 53 thereof is at a slight angle with respect to the light-entry opening 28 (not illustrated here). In order to minimize optical aberrations caused by the cover glass 38, the wedge angle and the position of the cover glass relative to the optical axis 50, i.e. the tilt, can be adapted to one another. In these cases, both the front side and the back side of the cover glass 38 can be arranged at an angle to the optical axis 50, wherein the respective oblique angle between the normal vector on the front side and the optical axis and/or the normal vector on the back side and the optical axis is different for the front side and the back side. In other words, the cover glass can, in addition to the wedge angle, also be arranged obliquely with respect to the optical axis.

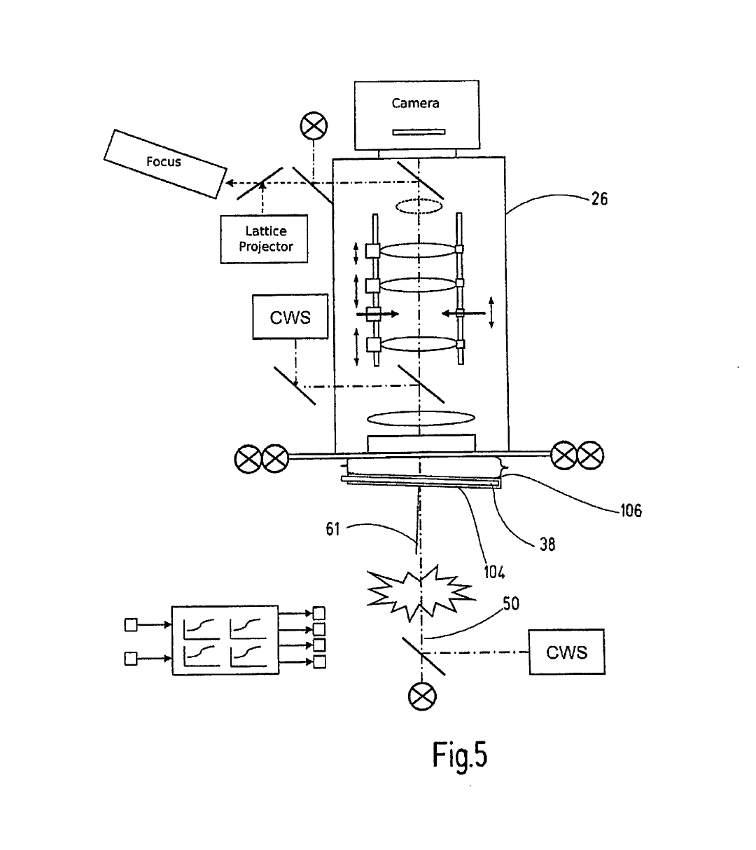

In further exemplary embodiments, of which one is illustrated in an exemplary fashion in FIG. 5, a cover glass with plane parallel front and back sides can be arranged at a slight angle with respect to the image sensor 36 or at an angle with respect to the optical axis 50. Here, the oblique angle between the normal vector on the front side and the optical axis is denoted by reference sign 61.

In accordance with FIG. 3, the cover glass 38′ can be realized by a thin film 57, which is clamped into a frame 59. The frame 59 can then be attached in a non-destructibly detachable manner on the light-entry opening 28 of the lens assembly 24.

As illustrated in FIG. 2 and FIG. 5, the second, third and fourth lens-element group 42, 44, 46 and the stop 52 can be displaced along the optical axis 50 (arrow 60) using the drives 58. This is how the lens assembly 24 can realize different magnifications and different working distances, enabling great flexibility.

In the preferred exemplary embodiments, a clear space 62 is provided between the first lens-element group 40 and the second lens-element group 42, which clear space even remains when the second lens-element group 42 is positioned at a minimum distance from the first lens-element group 40. Furthermore, a beam splitter 64 is arranged in the clear space 62 on the optical axis 50 in order, optionally, to couple in or decouple light from a further interface 66 of the lens assembly 24. In the preferred exemplary embodiments, the second interface 66 is arranged in the vicinity of the beam splitter 64 on the lateral circumference of the lens body 26.

Similarly, a further clear space 68, in which a beam splitter 70 may likewise be arranged, is situated between the fourth lens-element group 46 and the light-exit opening 30 in some exemplary embodiments of the lens assembly 24. There is a further interface 72, by means of which light may be coupled and/or decoupled, in the vicinity of the beam splitter 70. In the illustrated exemplary embodiment, the beam splitter 70 is arranged between the fifth lens-element group 48 and the light-exit opening 30. As an alternative or in addition thereto, the beam splitter 70 could be arranged between the fourth lens-element group 46 and the fifth lens-element group 48, which of course requires a corresponding clear space.

In preferred exemplary embodiments, the lens assembly 24 has a holder 74 in the region of the light-entry opening 28, on which holder different light sources 76, 78 are arranged. In the illustrated exemplary embodiment, the holder 74 carries an annular light with a plurality of light sources 78a, 78b, which are arranged around the lens body 26 at different radial distances. In some exemplary embodiments, the light sources 78a, 78b are able to generate light with different colors, for example white light, red light, green light and blue light, as well as mixtures thereof. The light sources 78a, 78b can be used to generate different illumination scenarios at different distances in front of the light-entry opening 28. At reference sign 80, a measurement object 80 is indicated schematically in an exemplary fashion, which measurement object is positioned at a distance d to the light-entry opening 28 of the lens assembly 24. The distance d represents a working distance between the lens assembly 24 and the measurement object 80, wherein this working distance can be variably set in response to focusing the lens assembly 24.

In the present exemplary embodiment, the light sources 76 are light sources which are integrated into the lens body 26. In some exemplary embodiments, the light sources 76 are integrated into the lens body 26 outside of the lens-element system, as illustrated in FIG. 2. In other exemplary embodiments, it is (alternatively or additionally) possible for light sources 76 to be integrated into the lens body 26 in such a way that the light generated by the light sources 76 emerges from the lens body 26 after passing through at least some of the lens elements and optionally the cover glass 38. In this case, the light-entry opening 28 is simultaneously also a light-exit opening.

Using the light sources 76, 78, it is possible to illuminate the measurement object 80 in a variable fashion, in order to generate a light field illumination and/or a dark field illumination, if desired. In both cases, this is incident light, which impinges on the measurement object 80 from the direction of the lens assembly 24.

The coordinate measuring machine 10 further comprises a light source 82 in preferred exemplary embodiments, which light source enables transmitted illumination of the measurement object 80. The light source 82 is accordingly arranged below the measurement object 80 or below the workpiece support of the coordinate measuring machine 10. The coordinate measuring machine 10 therefore comprises a workpiece support 12 in the preferred exemplary embodiments, which workpiece support is provided with a glass plate for enabling the transmitted illumination.

Finally the optical sensor 18 has a light source 84 in these exemplary embodiments, which light source is in this case coupled to the interface 72 via a further beam splitter. By means of the interface 72 and the beam splitter 70, the light source 84 is able to couple light into the whole beam path of the lens assembly 24. In this case, the coupled-in light is cast onto the measurement object 80 by means of the lens-element system of the first to the fourth (fifth) lens-element group. In some exemplary embodiments, the light source 84 can be a laser pointer, by means of which individual measurement points on the measurement object 80 can be illuminated in a targeted fashion. In other exemplary embodiments, the light source 84 can generate a structured light pattern, such as a strip pattern or a grid pattern, which is projected onto the measurement object 80 by the lens-element system of the lens assembly 24.

In a similar fashion, various illuminations can be coupled into the beam path of the lens assembly 24 via the interface 66 and, in principle, also via the light-exit opening 30. A grid projector is illustrated in an exemplary fashion at reference sign 86. The grid projector generates a structured light pattern, which, in this exemplary embodiment, is coupled into the beam path of the lens assembly 24 via two beam splitters and the interface 72.

As illustrated in FIGS. 2 and 5, the lens assembly 24 may be combined in various ways with optical sensors, which, as an alternative or in addition to the camera 34, serve for optical measurement of the measurement object 80. In the illustrated exemplary embodiment, a first confocal white-light sensor 88a is coupled to the interface 66. Alternatively, or in addition thereto, a further confocal white-light sensor 88b can, for example, be coupled into the illumination path for the transmitted illumination 82 via a beam splitter.

Reference sign 90 denotes an autofocus sensor, with the aid of which the elevation of the measurement object 80 parallel to the optical axis 50 can be established on the basis of determining the focal position. Moreover, an optical measurement of the measurement object 80 with the aid of the camera 34 and suitable image evaluation is possible, as known to persons skilled in the relevant art in this field.

In the preferred exemplary embodiments, the lens assembly 24 has a large range of application due to the displaceable lens-element groups 42, 44, 46 and the adjustable stop 52. In the preferred exemplary embodiments, a plurality of control curves 92 are stored in a storage device (not illustrated separately here) of the evaluation and control unit 22 or in another suitable storage device. In the preferred exemplary embodiments, the plurality of control curves 92 form a 2D family of curves, with the aid of which magnification and focusing of the lens assembly 24 can be set in numerous freely selectable combinations. Advantageously, the optical properties of the cover glass 38 are taken into account in the control curves and in the correction of the lens elements 40-48. In particular, the longitudinal chromatic aberration, which the lens assembly 24 generates in conjunction with the confocal white-light sensor 88a, is taken into account in the control curves and, more generally, in the calibration data for the measurement. In other words, the evaluation and control unit 22 evaluates the data from the white-light sensor 88a, taking into account the optical influence which the cover glass 38 has on the longitudinal chromatic aberration in particular.

In some exemplary embodiments, the lens assembly 24 includes a set with a plurality of cover glasses 38, which can optionally be attached to the lens body 26, wherein the plurality of cover glasses 38 generate various chromatic and/or spherical longitudinal aberrations of the lens assembly 24. For a measurement with the white-light sensor 88a, use can then advantageously be made of a cover glass which causes a relatively large longitudinal aberration, while a cover glass which causes a minimal longitudinal aberration is used for a measurement with one of the other sensors, for example the autofocus sensor 90 or the camera 34.

In the preferred exemplary embodiment, a user can enter a desired magnification 94 and desired focusing 96 into the evaluation and control unit 22. With the aid of the control curves 92 and depending on the desired magnification 94 and desired focusing 96, the evaluation and control unit 22 determines individual positions of the second, third and fourth lens-element groups along the optical axis 50, as well as an individual position and aperture of the stop 52. In some exemplary embodiments of the novel method, the user can vary the working distance d to a measurement object by varying this focusing, without the sensor 18 having to be moved relative to the measurement object with the aid of the quill 14. By way of example, this makes it possible to measure structures on the surface of a measurement object 80 and structures on the base of a bore (not illustrated here) of the measurement object 80 by virtue of, in the case of (almost) unchanging magnification, merely varying the focusing of the lens assembly 24 in such a way that, in one case, the structure on the top side of the measurement object 80 and, in the other case, the structure on the base of the bore lies in the focal plane of the lens assembly 24.

In other variants, a user may vary the magnification of the lens assembly 24 in the case of an unchanging or changing working distance d in order once again, for example, to measure details of a measurement object 80 previously measured “from a bird's eye view”.

Furthermore, a user is able, in some exemplary embodiments, to modify the numerical aperture of the lens assembly 24 by opening and closing the stop 52 in order thereby to achieve an unchanging resolution in the case of different working distances d. Furthermore, a user is able to vary the magnification, focusing, numerical aperture individually or combined with one another in order to adapt the lens assembly 24 in an optimum manner to the properties of the various sensors 36, 88, 90.

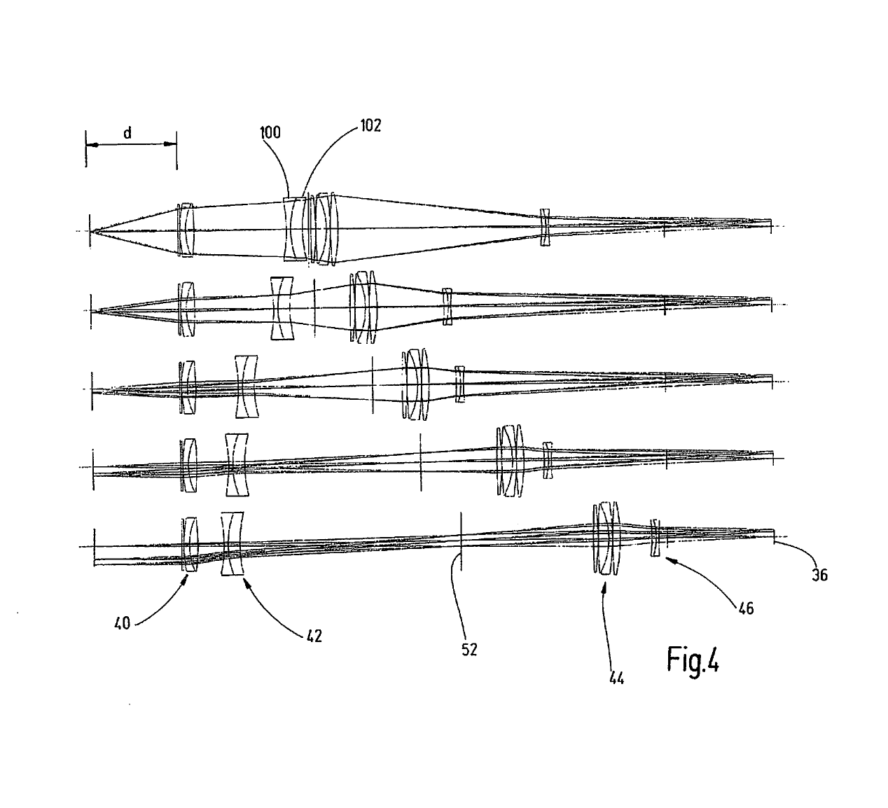

FIG. 4 illustrates by way of example various positions of the lens-element groups 40, 42, 44, 46 and the stop 52 for different magnifications. As can be identified from the sectional images, each lens-element group comprises several lens elements 100, 102, wherein, in this exemplary embodiment, use is made in each lens-element group of at least one cemented member consisting of at least two lens elements 100, 102. In one exemplary embodiment, the lens elements 100, 102 can be pushed apart with the aid of a piezo-actuator (not illustrated here) in order to generate a defined longitudinal chromatic aberration.

The lens assembly 24 can have transverse chromatic aberrations in order to enable a simple and cost-effective design. As a result of this, light and images in different colors have a slight offset across the optical axis 50 and possibly a slightly different linear magnification. In preferred exemplary embodiments, the transverse chromatic aberration and/or the linear magnification are corrected on the basis of mathematical correction calculations, which is possible in the preferred exemplary embodiments because the error image as such is continuous. To this end, the evaluation and control unit uses calibration data, which also represent the optical properties of the cover glass 38.

FIG. 5 shows an exemplary embodiment with a separate cover glass holder 104, which is connected to the holder 74 by means of a carrier ring 106 in this case. The carrier ring 106 has elastic regions, which, on the one hand, are under such pretension that the cover glass 38 is in this case angled relative to the optical axis 50 by the oblique angle 61. On the other hand, the elastic carrier ring 106 enables a relative movement between the cover glass holder 104 and the lens body 26. In the case of a collision, this can serve to protect the lens body and, in particular, the lens elements arranged therein, from damage.

In further exemplary embodiments, it is feasible to arrange the cover glass via an elastic holder but directly on the lens body. Moreover, the cover glass could be part of protective sleeve, which is arranged on the measuring head 16 and which surrounds the lens assembly 24 as a whole. In all preferred exemplary embodiments, the optical properties of the cover glass are taken into account in the lens-element correction of the lens assembly. Typically, the result is that spherical and chromatic aberrations, in particular, of the lens assembly are smaller with the cover glass than without the cover glass.

Moreover, in the preferred exemplary embodiments, the cover glass has a nano-coating on the front side 53, which reduces dirtying and simplifies cleaning due to the “lotus effect”. In particular, the coating has a structure as is used, for example, in the case of spectacle lenses.

What is claimed is:

1. A coordinate measuring machine for determining spatial coordinates on a measurement object, comprising:
a workpiece support for holding the measurement object,
a measuring head which can be displaced relative to the workpiece support and carries an optical sensor, and
an evaluation and control unit configured to determine geometric properties on the measurement object depending on a position of the measuring head relative to the workpiece support and depending on sensor data from the optical sensor;
wherein the optical sensor includes a lens assembly and a camera which is configured to record an image of the measurement object through the lens assembly,
wherein the lens assembly has a lens body which has a light-entry opening and a light-exit opening with an interface for connecting the camera,
wherein the lens assembly further comprises a stop and a number of lens elements, which are arranged in the lens body and together define an optical axis, and
wherein a separate cover glass is arranged in the region of the light-entry opening, which cover glass sits in front of the lens elements as first transparent component.

2. The coordinate measuring machine of claim 1, wherein the lens elements are corrected depending on the optical properties of the cover glass, such that at least one of spherical aberrations and chromatic aberrations of the lens assembly are smaller when the cover glass is installed than without the cover glass being installed.

3. The coordinate measuring machine of claim 1, wherein the cover glass has a planar front side and a planar back side, which are each arranged transversely with respect to the optical axis.

4. The coordinate measuring machine of claim 3, wherein lens assembly defines a depth-of-field range, and wherein the number of lens elements comprises a front-most lens element arranged next to the cover glass at a defined distance along the optical axis, with the defined distance being selected in such a way that the front side lies outside of the depth-of-field range.

5. The coordinate measuring machine of claim 3, wherein the front side and the back side are plane parallel to one another.

6. The coordinate measuring machine of claim 3, wherein the front side and the back side extend obliquely with respect to one another.

7. The coordinate measuring machine of claim 1, wherein the cover glass is arranged obliquely with respect to the optical axis.

8. The coordinate measuring machine of claim 1, wherein the cover glass is detachably connected to the lens assembly in the region of the light-entry opening.

9. The coordinate measuring machine of claim 1, wherein the lens body has a threaded lens body mount, into which the cover glass is detachably screwed.

10. The coordinate measuring machine of claim 1, further comprising a cover glass holder in the vicinity of the light-entry opening, said cover glass holder being flexibly connected to the lens body.

11. The coordinate measuring machine of claim 1, wherein the evaluation and control unit comprises a storage device with calibration data representing individual optical properties of the lens assembly, said evaluation and control unit being configured to determine the spatial coordinates using the calibration data, and said calibration data comprising data representing individual optical properties of the cover glass.

12. The coordinate measuring machine of claim 1, characterized by an orientation element, which determines a defined rotational position of the cover glass about the optical axis.

13. The coordinate measuring machine of claim 1, wherein the lens assembly comprises a seal, which seals the lens body together with the cover glass in a dust-tight or moisture-tight fashion.

14. The coordinate measuring machine of claim 1, wherein the cover glass comprises a frame, into which an inherently flexible, transparent film is clamped to form the cover glass.

15. The coordinate measuring machine of claim 1, wherein the cover glass has a rigid glass body.

16. The coordinate measuring machine of claim 1, wherein the cover glass is provided with a nano-coating with lotus effect.

17. The coordinate measuring machine of claim 1, comprising a set with a plurality of different cover glasses each configured to be selectively coupled to the lens body, wherein the plurality of cover glasses are configured to generate various chromatic aberrations.

18. A lens assembly for a coordinate measuring machine, comprising:
a lens body having a light-entry opening, a light-exit opening and an interface for connecting a camera, and
a stop and a number of lens elements which are arranged in the lens body and together define an optical axis;
wherein a separate cover glass having a planar front side and a planar back side is arranged in the region of the light-entry opening, which cover glass has optical characteristics and sits in front of the lens elements as a first transparent component at the light-entry opening,
wherein the lens elements are corrected as a function of the optical characteristics, such that at least one of spherical aberrations and chromatic aberrations of the lens assembly are smaller when the cover glass is installed than without the cover glass being installed.
